(19) United States
(12) Patent Application Publication
(10) Pub. No.: US 2003/0234756 A1
(43) Pub. Date: Dec. 25, 2003

(54) Method for independently adjusting single color on a display device

(75) Inventors: Chao-Chee Ku, Hsin-Chu (TW); Yen-Tsang Chen, Hsin-Chu (TW); Joe Yang, Hsin-Chu (TW)

Correspondence Address: BACON & THOMAS, PLLC, 625 SLATERS LANE, FOURTH FLOOR, ALEXANDRIA, VA, 22314

(73) Assignee: WELTREND SEMICONDUCTOR, INC., Hsin-Chu (TW)

(21) Appl. No.: 10/284,152

(22) Filed: Oct. 31, 2002

(30) Foreign Application Priority Data
Jun. 25, 2002 (TW) 091113941

(51) Int. Cl. G09G 5/10

(52) U.S. Cl. 345/88

(57) ABSTRACT

A method is proposed for independently adjusting single color on a display device, which contains following steps: detecting multiple pixels of a display device, and separating out the 1^{st} and the 2^{nd} tint of these pixels; if the 1^{st} and the 2^{nd} tint of a pixel are with the same color class, then adjust the color of the pixel; and if the 1^{st} and the 2^{nd} tint of a pixel are with the different color classes, then maintain the color of the pixel in the original status.

### FIELD OF THE INVENTION

The present invention is relative to a method for independently adjusting single color on a display device, and more particularly to a method for detecting every pixel on a display device and adjusting single color to meet the requirement with a better display result for a user.

### BACKGROUND OF THE INVENTION

There are two color coordinates used to show the color displaying on a screen. The one is RGB system (generally, RGB is used to indicate the three original colors without gamma correction, and R′G′B′ is used to indicate the colors with gamma correction) and the other is Y, Cb, Cr system (or Y, U, V; or Y, Pb, Pr). And, the format that display on a screen such as TFT-LCD is R′G′B′.

FIG. 1 shows the RGB color coordinate system. In the RGB color coordinate system the adjustment with one color is related to a cube style. Whenever one of the axes is adjusted, the whole color will be affected, so the control of a specific color such as Yellow is very difficult, if not impossible. Therefore, we generally transfer the RGB axial coordinate into Y (illumination), Cb (the 1^{st} tint), and Cr (the 2^{nd} tint) format (or Y, U, V; or Y, Pb, Pr).

FIG. 2 shows the coordinate diagram of Y, Cb, Cr. After color space conversion, RGB can be converted to Y, Cb, Cr, and can be simply controlled by two parameters (Cb, Cr), so most of the video image systems use Y, Cb, Cr (or Y, U, V; or Y, Pb, Pr) to represent every pixel's color.

The display of general display devices can be adjusted by different users' requirements. Taking an example by the adjustment of blue color, someone prefers magenta-oriented, but someone prefers cyan-oriented. But the traditional adjustment of display device colors cannot adjust a single color independently. Therefore, when one color is adjusted during tuning, the other colors will be adjusted simultaneously, so the display of the screen may be incongruent. For example, when we adjust the blue color, it means that the blue (B) element of every pixel will be adjusted, that is, all the blue parts will be changed and all the other colors of the screen will also be affected. Further more, if we use Y, Cb, Cr coordinate system and adjust Cb or Cr only, then whole the screen would have the same affection. This is the drawback of hue adjustment of traditional display display devices. Due to the colors cannot be adjusted independently, so the screen colors cannot be tuned to a well condition.

### PURPOSE OF THE INVENTION

The objective of the present invention is providing an independent single color adjustment method of a display device, which detects every pixel's color, identifies the color class of it, and decides whether to adjust the pixel's color or not. Since every color class can be adjusted independently, this makes the color adjustment of a display device commits an individual's particular requirement possible.

### SUMMARY OF THE INVENTION

According to the present invention, we provide a method for independently adjusting single color on a display device, which contains following steps:

Detecting every pixel of a display device, and calculating the 1^{st} and the 2^{nd} tint of this pixel;

From the 1^{st} and the 2^{nd} tint of a pixel, it can be concluded if it is in the color class which we would like to adjust it, if so, then adjust the color of the pixel; and

If the pixel is not in the target color class, then just keep the color of the pixel in the original status.

In accordance with one aspect of the present invention, the display device is a flat panel display (FPD) such as TFT-LCD Panel or PDP.

In accordance with one aspect of the present invention, the 1^{st} tint is Cb, and the 2^{nd} tint is Cr.

In accordance with one aspect of the present invention, the color class includes six independent color classes.

In accordance with one aspect of the present invention, the six independent color classes are Red class, Yellow class, Green Class, Cyan class, Blue class, and Magenta class.

In accordance with one aspect of the present invention, the six independent color classes take the area with 60 degrees in the two dimensions of Cb, Cr, respectively: the Red class is between 81.5 to 140.5 degrees, the Yellow class is between 41.5 to 200.5 degrees, the Green classis between 201.5 to 260.5 degrees, and Cyan class is between 261.5 to 320.5 degrees, the Blue class is between 321.5 to 20.5 degrees, and the Magenta class is between 21.5 to 80.5 degrees.

In accordance with one aspect of the present invention, the multiple pixels of the display device are the pixels in one of the display device's windows.

In accordance with one aspect of the present invention, the multiple pixels of the display device are all the pixels of the display device.

The present invention may best be understood through the following description with reference to the accompanying drawings, in which:

### BRIEF DESCRIPTION OF THE DRAWINGS

FIG. 1 is a traditional RGB axial coordinate for three-dimension.

FIG. 2 is the traditional Y (Cb) (Cr) axial coordinate system.

FIG. 3 is the color classes diagram according to the present invention.

FIG. 4 is the single color adjustment flow chart according to the present invention.

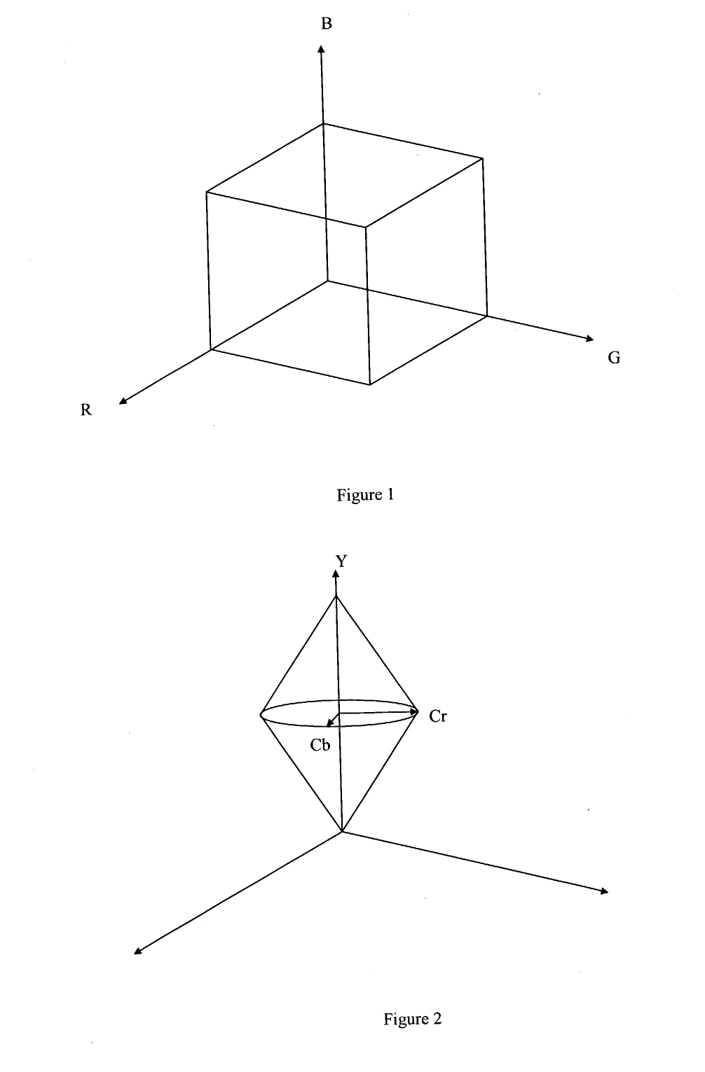

### DETAILED DESCRIPTION OF THE PREFERRED EMBODIMENT

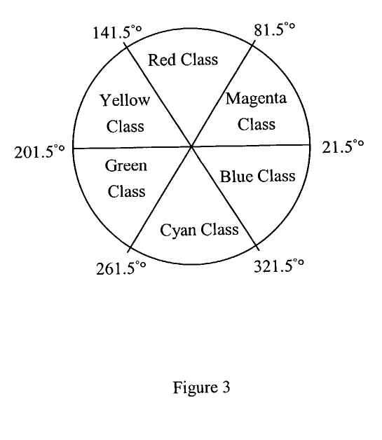

Please refer to FIG. 3. By Y (Cb) (Cr) axial coordinate, we may decide the six color classes by the (Cb) (Cr) axes:

1. The Red class is between 81.5 to 140.5 degrees;

2. The Yellow class is between 141.5 to 200.5 degrees;

3. The Green class is between 201.5 to 260.5 degrees;

4. The Cyan class is between 261.5 to 320.5 degrees;

5. The Blue class is between 321.5 to 20.5 degrees;

6. The Magenta class is between 21.5 to 80.5 degrees.

The previous six color classes are the Cb, Cr angles in the Y, Cb, Cr axial coordinate, and the Y, Cb, Cr axial coordinate can be transferred from RGB axial coordinate by following calculation:

Y′₆₀₁=0.299R′+0.587G′+0.114B′

Cb=−0.168736R′−0.331264G′+0.5B′

Cr=0.5R′−0.418688G′−0.081312B′ (1)

Where R′, G′, B′ are the gamma corrected results of R, G, B, respectively. Also, Y′₆₀₁ can be Y′₇₀₉ for HDTV.

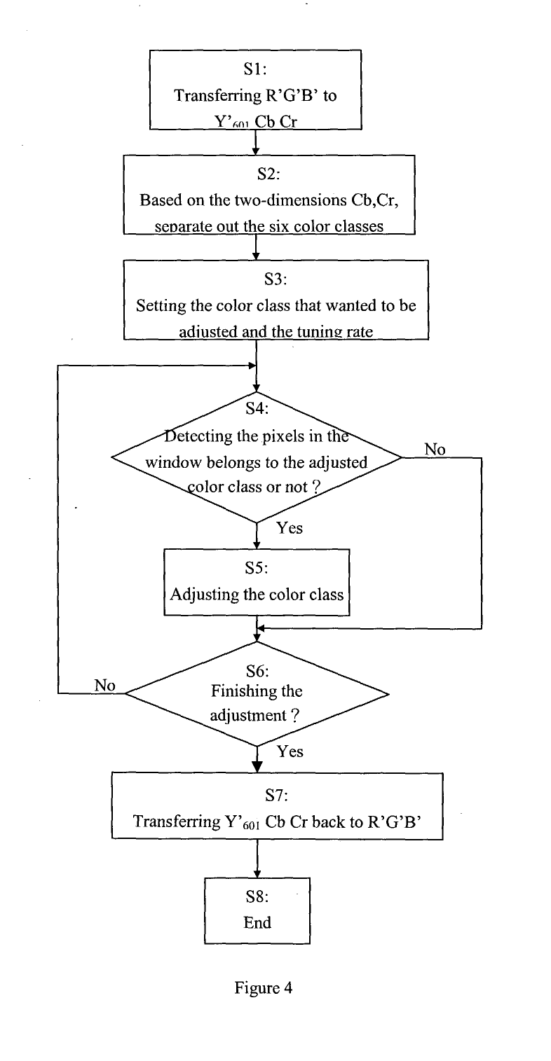

FIG. 4 shows the independent single color (Blue class) adjustment flow chart of the present invention, which contains the following steps:

S1: By (1), transferring R′G′B′ to Y′₆₀₁,Cb,Cr axial coordinate.

S2: Separating the six color classes by Cb, Cr.

S3: Setting the color class that will be adjusted (for example by Blue color) and the adjustment rate, i.e., degree of variation.

S4: Detecting the pixels in the window and deciding if it belongs to Blue class by using the triangular function tangent and the value of Cb, Cr. If the pixels are Blue class, then go to S5; if the pixels are not Blue class, then go to S6.

S5: Adjustment the Blue class by the adjustment rate, i.e., degree of variation.

S6: Check if every pixel in the window has been adjusted already? If yes, then go to S7; else go to S4.

S7: Transferring Y′₆₀₁,Cb,Cr back to R′G′B′ axial coordinate for displaying on the display device.

S8: Adjustment process is finished.

Of course, the flow chart in the FIG. 4 can be used on the other 5 color classes, not only for Blue color. The proposed method can be implemented by logic circuitry, and the adjustment process cab be performed by a software operation interface. By this software operation interface, such as Graphical User Interface (GUI), the adjustment rate of every color class can be adjusted directly.

Attachment 1 is the result of simulation (color picture), which adjusts the six color classes by ±25%. In the window we may find that the adjusted color classes will have obvious variation from the original one, and the non-adjusted color classes will remain in the original color.

In theory, the present invention is a method for independently adjusting single color on a display device, which is used by detecting multiple pixels of a display device, obtaining the Cb and Cr tints of the pixels, and adjusting the pixel's color if the detected pixel is within the color class which we like to change it a little bit, and remaining the original color of the pixel if the detected pixel is not the target color class.

In technique, the display device is a TFT-LCD panel or a PDP, and the color contains six independent classes. The six independent color classes are Red class, Yellow class, Green class, Cyan class, Blue class, and Magenta class. These six independent color classes take the area with 60 degrees in the two-dimensions of Cb, Cr, respectively: the Red class is between 81.5 to 140.5 degrees, the Yellow class is between 41.5 to 200.5 degrees, the Green classis between 201.5 to 260.5 degrees, and Cyan class is between 261.5 to 320.5 degrees, the Blue class is between 321.5 to 20.5 degrees, and the Magenta class is between 21.5 to 80.5 degrees. The multiple pixels of the display device could be the pixels in one of the display device's windows. And the multiple pixels of the display device also could be all the pixels of the display device.

To sum up, in the traditional Hue adjustment process where when a color class is adjusted, other color classes will also be affected and changed, in this invention, however, changing a color class will not affect other color classes. Therefore, we can adjust every single color independently to commit the users' requirements.

[image]

[image]

[image]

[image]

[image]

[image]

What is claimed is:

1. A method for independently adjusting single color on a display device, comprising steps of:
detecting a plurality of pixels of a display device for separating out a first tint and a second tint of every pixel;
adjusting said color of said pixel according to said first tint and said second tint of a pixel with said same color class ; and
maintaining said color of said pixel in said original status according to said first tint and said second tint of said pixel with said different color classes.

2. A method according to claim 1 wherein said display device is a LCD.

3. A method according to claim 1 wherein said first tint is Pb and said second is Pr.

4. A method according to claim 3 wherein said color class includes six independent color classes.

5. A method according to claim 4 wherein said six independent color classes are a red class, a yellow class, a green class, a cyan class, a blue class, and a magenta class.

6. A method according to claim 5 wherein said six independent color classes take a area with 60 degrees in a two dimensions of Pb, Pr, respectively: said red class is between 81.5 to 140.5 degrees, said yellow class is between 41.5 to 200.5 degrees, said green class is between 201.5 to 260.5 degrees, and said cyan class is between 261.5 to 320.5 degrees, said blue class is between 321.5 to 20.5 degrees, and said magenta class is between 21.5 to 80.5 degrees.

7. A method according to claim 1 wherein said plurality of pixels of said display device are a plurality of pixels in a windows of said display device.

8. A method according to claim 1 wherein said plurality of pixels of said display device is all said pixels in said display device.
